(19) United States
(12) Patent Application Publication
(10) Pub. No.: US 2017/0043352 A1
(43) Pub. Date: Feb. 16, 2017

(54) GRAVITY PARTICULATE SEPARATOR

(71) Applicant: James Gregory ROSS, Alanson, MI (US)

(72) Inventor: James Gregory ROSS, Alanson, MI (US)

(21) Appl. No.: 14/825,685

(22) Filed: Aug. 13, 2015

(51) Int. Cl. B03B 5/62

(52) U.S. Cl. CPC B03B 5/623

(57) ABSTRACT

A gravity separator that uses the upthrust of an upwardly flowing fluid to separate desired particulate from a material composite of a plurality of particulate is provided. The gravity separator may include a vertically oriented flow tube that is fluidly connected to an inlet tube, an outlet tube and a collection container, wherein the outlet tube is oriented upward from the inlet tube, which in turn is upward from the collection container. The inlet tube may receive a material composite including a plurality of non-desired particulate, conforming desired particulate and non-confirming desired particulate, which are subject to upthrust through the segment of the flow tube between the inlet tube and the outlet tube, the teetering chamber, so that only the conforming desired particulate sinks to the collection container.

### BACKGROUND OF THE INVENTION

The present invention relates to solid material separators and, more particularly, a gravity separator that uses the upthrust of an upwardly flowing fluid to separate desired particulate from a material composite of a plurality of particulate.

Currently, when separating solid materials, gold prospectors, geology enthusiasts, and the like still utilize panning because of its cheap cost, portability and relatively simple and easy process. However, panning is time consuming and so a user may work but a limited amount of material. Furthermore, because panning requires hand agitation and spilling to separate the material, there is a learning curve as well as an opportunity for human error as it relates to the user's manual dexterity. Alternative means of separating solid materials involve the use of mercury of other toxic chemical elements.

As can be seen, there is a need for separating solid materials that is still, like panning, portable, has no moving parts, easy and inexpensive, yet lends itself to quicker results without the use of mercury and independent on the user's fine motor skills.

### SUMMARY OF THE INVENTION

In one aspect of the present invention, a gravity particulate separator includes a vertically oriented flow tube forming at least one fluid inlet; an inlet tube fluidly communicating with the flow tube, wherein the inlet tube interfaces with the flow tube at an inlet angle and upward from the at least one fluid inlet; and an outlet tube fluidly communicating with the flow tube, wherein the outlet tube interfaces with the flow tube at an outlet angle and upward from the inlet tube so as to form a teetering chamber along the flow tube between the inlet tube and the outlet tube.

In another aspect of the present invention, gravity particulate separator includes a vertically oriented flow tube forming at least one fluid inlet; a fluid source fluidly connected to the at least one fluid inlet; an inlet tube fluidly communicating with the flow tube, wherein the inlet tube interfaces with the flow tube at an inlet angle and upward from the at least one fluid inlet; a collection container fluidly communicated with the flow tube downward from the at least one fluid inlet; and an outlet tube fluidly communicating with the flow tube, wherein the outlet tube extends approximately 8 inches to interface with the flow tube at an approximately 40 degree outlet angle and upward from the inlet tube so as to form a teetering chamber along the flow tube between the inlet tube and the outlet tube, wherein the flow, inlet and outlet tubes are made of transparent material and each tube forms a rectangular shape.

These and other features, aspects and advantages of the present invention will become better understood with reference to the following drawings, description and claims.

### BRIEF DESCRIPTION OF THE DRAWINGS

FIG. 1 is a front cross-sectional view of an exemplary embodiment of the present invention;

FIG. 2 is a front cross-sectional view of an exemplary embodiment of the present invention, demonstrating an initial stage of operation;

FIG. 3 is an enlarged detail view of an exemplary embodiment of the present invention, taken along line 3-3 of FIG. 2;

FIG. 4 is a front cross-sectional view of an exemplary embodiment of the present invention, demonstrating a later stage of operation;

FIG. 5 is a cross-sectional view of an exemplary embodiment of the present invention, taken along line 5-5 of FIG. 1; and

FIG. 6 is a schematic cross-sectional view of an exemplary embodiment of the present invention, demonstrating a shaker with mesh screens for sizing particles before extraction.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a gravity separator that uses the upthrust of an upwardly flowing fluid to separate desired particulate from a material composite of a plurality of particulate. The gravity separator may include a vertically oriented flow tube that is fluidly connected to an inlet tube, an outlet tube and a collection container, wherein the outlet tube is oriented upward from the inlet tube, which in turn is upward from the collection container. The inlet tube may receive a material composite including a plurality of non-desired particulate, conforming desired particulate and non-confirming desired particulate, which are subject to upthrust through the segment of the flow tube between the inlet tube and the outlet tube, the teetering chamber, so that only the conforming desired particulate sinks to the collection container.

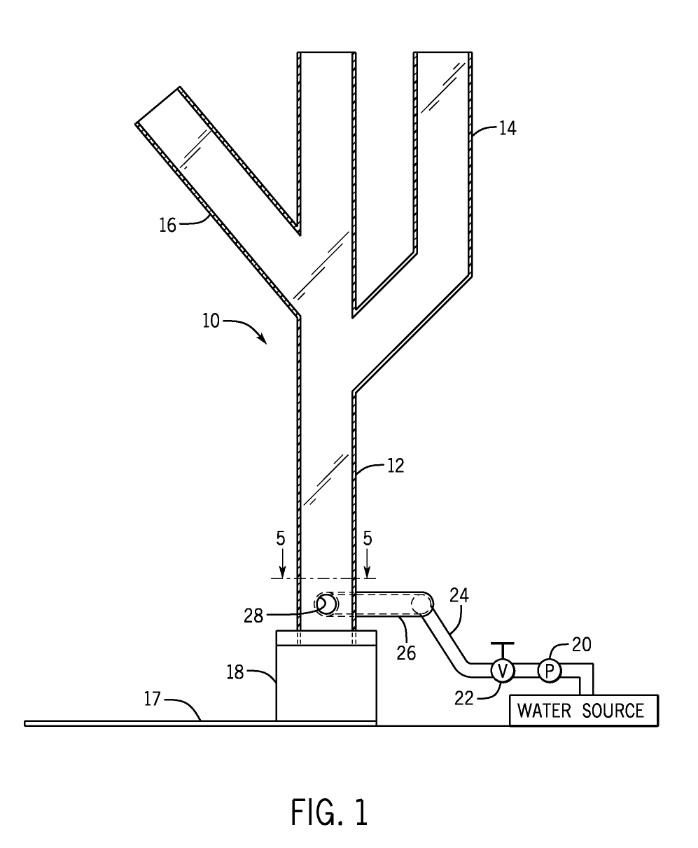

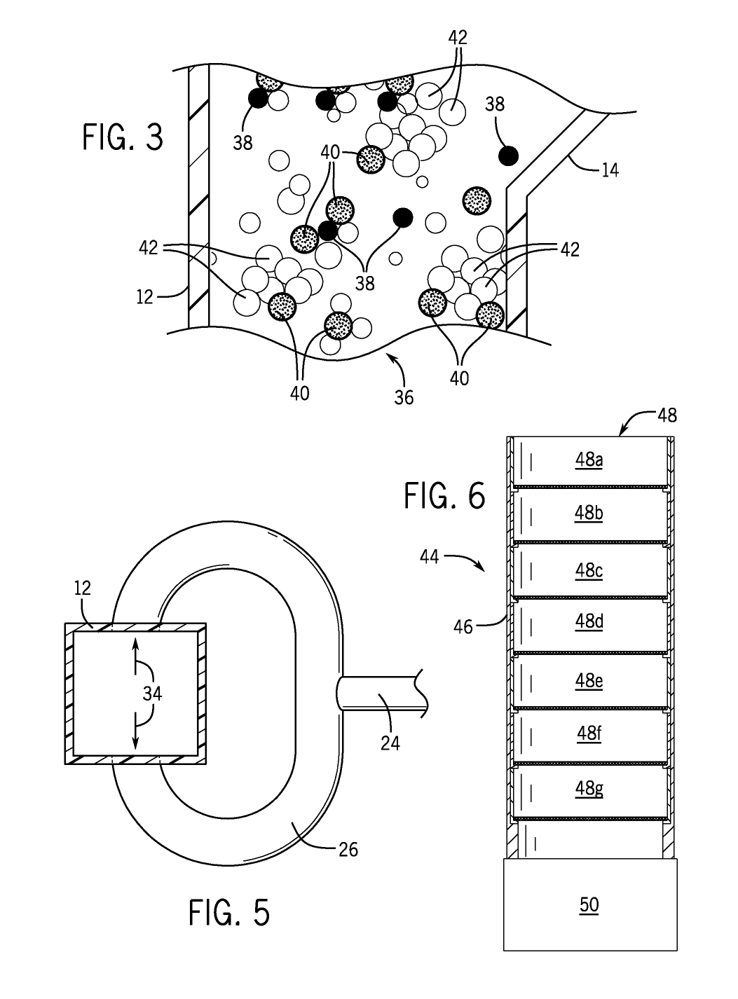

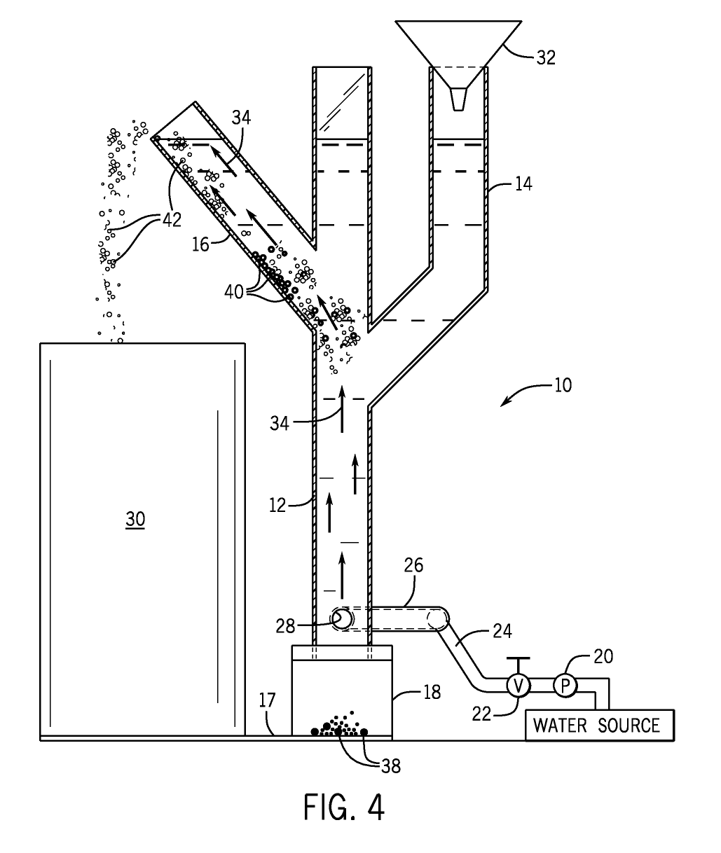

Referring to FIGS. 1 through 5, the present invention may include a gravity separator 10. The gravity separator 10 may include a generally vertically-oriented flow tube 12 in fluid communication with a manifold 26, an outlet tube 16, an inlet tube 14, and a collection container 18. The flow tube 12 may or may not form an upward opening or be sealed off.

The tubing 12, 14, 16 may be made of transparent material formed into a generally rectangular shape, defining a continuous square opening that a fluid may flow through and be visually perceived. The rectangular shape may be preferably to cylindrical shapes as it allows the outlet tube 16 and the inlet tube 14 to be disposed close to each other for the sake of compactness.

The manifold 26 may be fluidly connected to the flow tube 12 through at least one fluid inlet 28. The manifold 26 may fluidly interconnect the at least one fluid inlet 28 through piping 24 to a fluid valve 22 and a fluid pump 20 so as to provide a fluid source of fluid 34 urged to flow in an upwardly direction through the flow tube 12 at variable rates of flow. It should be understood that directional or orientation-related terms such as upward, vertical, downward and the like may be defined in relation to the direction of gravity relative to a generally horizontal supporting surface 17. The fluid valve 22 may be adapted to control the rate of flow of the fluid 34 through the flow tube 12 at a predetermined or desired rate.

The collection container 18 may be connected to the flow tube 12 downward from the fluid inlet 28, as illustrated in FIG. 1, whereby particulate that sinks through the flow tube 12 will eventually gather in the collection container 18 absent an increase in flow rate of the fluid 34 or the particulate's density.

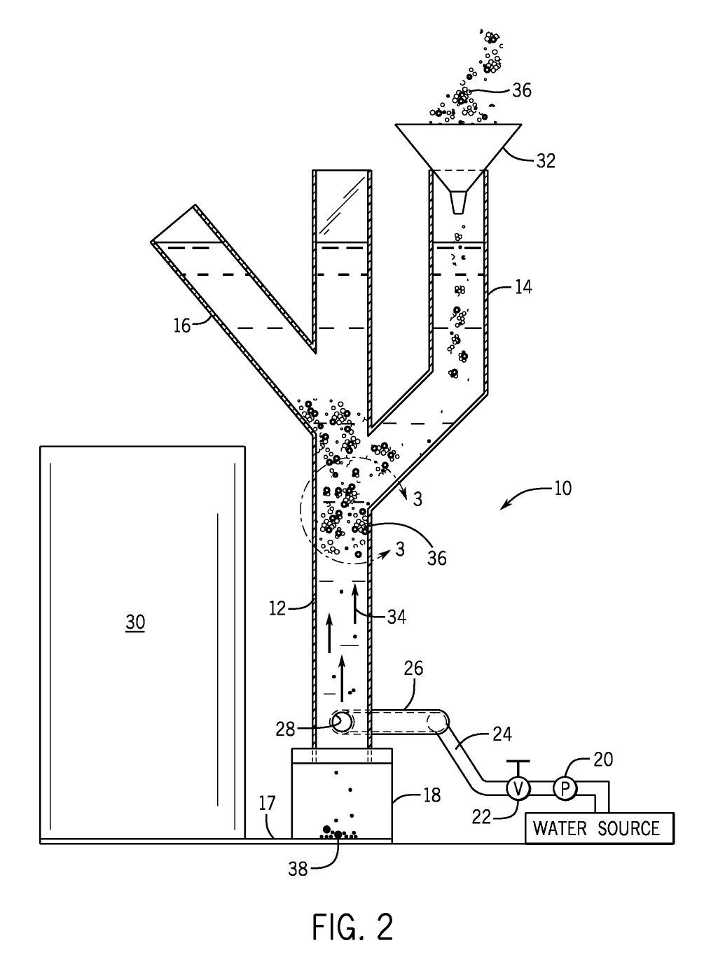

At their fluid interface, the inlet tube 14 may be oriented at an angle to the flow tube 12 and then transition to a generally vertical orientation when it terminates in an inlet opening, as illustrated in FIG. 2. The inlet opening may be dimensioned and adapted to operatively engage a funnel 32.

At their fluid interface, the outlet tube 16 may be oriented at an outlet angle to the flow tube 12. In certain embodiments, the outlet angle may be approximately 40 degrees to facilitate the capture of non-conforming configurations of a desired particulate. In certain embodiments, the length of the outlet tube 16 may be approximately 8 inches in length. The outlet tube 16 may form an outlet opening through which discharged flowing fluid 34 flows. A tailings container 30 may be disposed beneath the outlet opening so that the discharged flowing fluid 34 and any particulate (tailings) therein may be received in. In certain embodiments, the tailings container 34 may be fluidly connected to the outlet opening.

A method of using the present invention may include the following. The gravity separator 10 disclosed above may be provided. A user may engage the pump 20 and valve 22 so that a predetermine rate of flow of a fluid 34 is flowing upwardly through the flow tube 12. Then the user may load the inlet tube 14 with a material composite 36, in certain embodiments by means of the funnel 32, so that it is received between the inlet tube fluid interface and the outlet tube fluid interface—i.e., the teetering chamber, as illustrated in FIG. 2. The material composite 36 may include a conforming desired particulate 38, non-conforming desired particulate 40, and a plurality of non-desired particulate 42. Each particulate 38, 40, 42 may have different densities, specific gravity in reference with the fluid 34, and other physical (such as size) and material properties. As a result, the upward force exerted by the fluid 34 that opposes the weight of each immersed particulate 38, 40, 42, whereby the resulting pressure causes each immersed particulate 38, 40, 42 to float up or sink down at different rates along the flow tube 12 and the teetering chamber. All things being equal, the heavier particles would tend to sink to the collection container 18 will the lighter particles would tend to float up into the outlet tube 16 and into the tailings collector 30.

Using this method, the user hoping to isolate a heaver desired particulate 38 in the collection container 18 may adjust the rate of fluid flow for this purpose. Moreover, the non-conforming desired particulate 40 may have at least one physical configuration, for example flakey physical property, whose density urges it through the outlet tube 16 along with the undesired particulate 42. Alternatively, the outlet angle and length of the outlet tube 16 may be dimensioned and adapted along with the teetering chamber so that the non-conforming desired particulate 40 will catch in a low velocity eddy loop until the end of a cycle, wherein it is drained away to be separately panned.

Referring to FIG. 6, the present invention may include a shaker 44 having a shaker body 46 extending from a shaker opening downward to a shaker base 50. The shaker body 46 may include a plurality of sieve and/or mesh elements 48. In certain embodiments, the plurality of sieve and/or mesh elements 48 may include a range of mesh screens for sizing particles from mesh size four 48a, through a plurality of intermediate sizes 48b-48f, up through mesh size ninety 48g. The user may employ the shaker 44 to classify by size the material composite 36 to be used through each cycle. Thereby, after running one size classification through the gravity separator 10 as a predetermined rate of flow, the user may reset the predetermined rate of flow as a function of a new size classification for the next cycle.

It should be understood, of course, that the foregoing relates to exemplary embodiments of the invention and that modifications may be made without departing from the spirit and scope of the invention as set forth in the following claims.

What is claimed is:

1. A gravity particulate separator, comprising:
a vertically oriented flow tube forming at least one fluid inlet;
an inlet tube fluidly communicating with the flow tube, wherein the inlet tube interfaces with the flow tube at an inlet angle and upward from the at least one fluid inlet; and
an outlet tube fluidly communicating with the flow tube, wherein the outlet tube interfaces with the flow tube at an outlet angle and upward from the inlet tube so as to form a teetering chamber along the flow tube between the inlet tube and the outlet tube.

2. The gravity particulate separator of claim 1, wherein the flow, inlet and outlet tubes are made of transparent material.

3. The gravity particulate separator of claim 2, wherein the flow, inlet and outlet tubes each form a rectangular shape.

4. The gravity particulate separator of claim 1, further comprising a collection container fluidly communicated with the flow tube downward from the at least one fluid inlet.

5. The gravity particulate separator of claim 4, further comprising a fluid source fluidly connected to the at least one fluid inlet.

6. The gravity particulate separator of claim 1, wherein the outlet angle is approximately 40 degrees.

7. The gravity particulate separator of claim 6, wherein the outlet tube extends for approximately eight inches in length.

8. A gravity particulate separator, comprising:
a vertically oriented flow tube forming at least one fluid inlet;
a fluid source fluidly connected to the at least one fluid inlet;
an inlet tube fluidly communicating with the flow tube, wherein the inlet tube interfaces with the flow tube at an inlet angle and upward from the at least one fluid inlet;
a collection container fluidly communicated with the flow tube downward from the at least one fluid inlet; and
an outlet tube fluidly communicating with the flow tube, wherein the outlet tube extends approximately 8 inches to interface with the flow tube at an approximately 40 degree outlet angle and upward from the inlet tube so as to form a teetering chamber along the flow tube between the inlet tube and the outlet tube,
wherein the flow, inlet and outlet tubes are made of transparent material and each tube forms a rectangular shape.

9. A method of separating a desired particulate from a material composite include at least one non-desired particulate using the gravity particulate separator of claim 8, comprising:
loading the material composite through the inlet tube; and
varying a rate of flow of the fluid source between the teetering chamber so that the at least the desired particulate sinks to the collection container and the at least one non-desired particulate enters the outlet tube.

10. The method of claim 9, further comprising classifying the pre-loaded material composite by size so that the material composite can be loaded with different classifications of size for each of a plurality of cycles.
